(19) United States
(12) Patent Application Publication
(10) Pub. No.: US 2009/0159502 A1
(43) Pub. Date: Jun. 25, 2009

(54) Decomposition of peroxides using iron-containing acidic zeolites

(76) Inventors: Laszlo T. Nemeth, North Barrington, IL (US); Susie Martins, Prospect Heights, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 12/002,919

(22) Filed: Dec. 19, 2007

(51) Int. Cl. C10G 45/04; B01J 29/072; C01B 33/26

(52) U.S. Cl. 208/217; 502/74; 423/700

(57) ABSTRACT

The present invention provides a catalyst particle for decomposing a peroxide compound into an alcohol compound, the catalyst particle having an acidic zeolite material having an iron containing material in the framework position or the non-framework position and being present in an amount by weight of the catalyst particle from 100 ppm to 10,000 ppm.

### FIELD OF THE INVENTION

The present invention is directed to a process for decomposing unreacted peroxides used in a process for the oxidative desulfurization of diesel. Sulfur compounds are oxidized in a hydrocarbon feed stream using peroxide compounds as an oxidizing agent. These peroxide compounds are generated in-situ within the feedstream by auto-oxidation, and are then used in conjunction with a catalyst to further oxidize the refractory sulfur compounds to sulfones. Because this oxidation step is not exclusively selective for sulfur-containing compounds, an excess of peroxide is used. We have discovered a very efficient catalyst for the decomposition of these residual peroxides. Subsequent removal of the sulfones from the product stream, results in an ultra low sulfur diesel fuel.

### BACKGROUND OF THE INVENTION

Organic sulfur contaminants, while ubiquitous in hydrocarbon products such as straight run and refined hydrocarbon streams including gasoline, diesel fuel, and kerosene, are suspected of causing adverse environmental effects when converted to sulfur oxides (SOₓ) upon combustion. SOₓ emissions are believed to contribute not only to acid rain, but also to reduced efficiency of catalytic converters designed to improve motor vehicle exhaust quality. Furthermore, sulfur compounds are thought to ultimately increase the particulate content of combustion products. For these reasons, the reduction of the sulfur content in hydrocarbon streams has become a major objective of recent environmental legislation worldwide. Canada, Japan, and the European Commission have all recently adopted a 0.05 wt % limit on diesel fuel sulfur.

For the oil refiner, complying with such increasingly stringent specifications has primarily meant using more severe hydrotreating conditions. Hydrotreating refers to a well-known process whereby hydrogen is contacted with a hydrocarbon stream and catalyst to produce a number of desirable reactions, including the conversion of sulfur compounds to hydrogen sulfide. This reaction product is then separated into a gaseous hydrotreater effluent stream and thus effectively removed from the hydrocarbon product. Hydrotreating can readily reduce the level of several common classes of sulfur compounds such as sulfides, disulfides, and thiols (mercaptans) present in refinery products. Unfortunately, hydrotreating (or hydrodesulfurization) often fails to provide a treated product in compliance with the strict sulfur level targets currently demanded. This is due to the presence of refractory sulfur compounds such as unsubstituted and substituted thiophenes in hydrotreating environments. Attempts to completely convert these species, which are more prevalent in heavier feed stocks such as diesel fuel and fuel oil, have resulted in an increase to equipment costs and more frequent replacement of the catalyst. The product quality is also degraded due to undesirable side reactions.

Several prior art disclosures address sulfur contamination in refinery products. U.S. Pat. No. 2,769,760, for example, describes a hydrodesulfurization process with an additional conversion step that does not further reduce the sulfur level but converts some sulfur species to less-corrosive forms, allowing the product to meet acidity requirements. Other disclosures are more specifically directed toward complete sulfur removal from hydrocarbons. Particularly, the ability to oxidize sulfur compounds that are resistant to the aforementioned hydrogenation method is recognized in a number of cases. Oxidation has been found to be beneficial because oxidized sulfur compounds are more easily removed from the hydrocarbon feed by means of extraction, precipitation, or adsorption onto silica or alumina.

### BRIEF SUMMARY OF THE INVENTION

The present invention is directed to an oxidative desulfurization process which complements hydrotreating. Sulfur-containing compounds which are found to be refractory under hydrotreating conditions such as benzothiophene, dibenzothiophene, and other homologs, are found to be more easily oxidized than mercaptans, thioethers, and disulfides, which are easier to hydrodesulfurize. Instead of using hydrogen peroxide or an organic peroxide to carry out the oxidation, diesel was autoxidized to generate peroxides in-situ. This autoxidized sulfur-containing feed is passed over a catalyst capable of oxidizing sulfur species to sulfones. Because the catalyst is not selective for sulfur oxidation, 10 to 20 equivalents of peroxide per sulfur molecule are usually used to carry out the reaction. After sulfone generation, the product diesel is passed over silica gel to absorb the sulfones and other polar molecules, including unreacted peroxides. To get more life out of the silica gel and increase the capacity of sulfur compounds on the silica gel, a novel catalyst has been found to be very efficient in the decomposition of residual peroxides prior to silica gel adsorption. Finally, ultra-low sulfur diesel is collected at the reactor outlet.

### BRIEF DESCRIPTION OF THE DRAWINGS

FIG. 1 is a schematic representation of a method and apparatus for preparing an ultra-low sulfur diesel effluent from a high-sulfur content diesel feed stream.

FIG. 2 is a bar chart plotting the percent peroxide decomposition (y-axis) versus the type of catalyst used (x-axis).

FIG. 3 is a bar chart plotting the percent peroxide decomposition (y-axis left scale) and the iron content by weight in parts per million (wppm) of each catalyst type (y-axis right scale) versus the type of catalyst (x-axis).

### DETAILED DESCRIPTION OF THE INVENTION

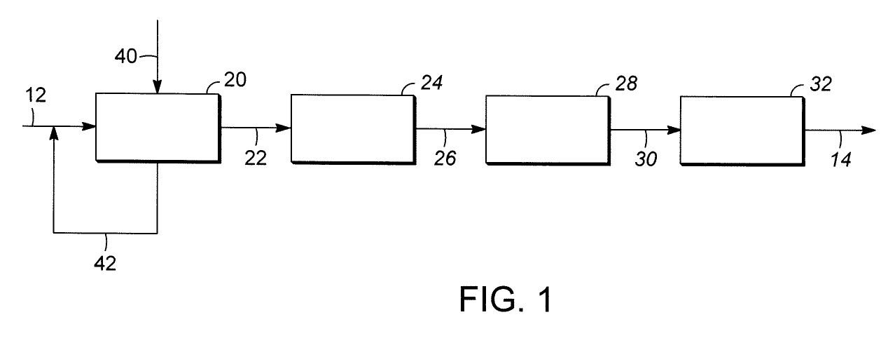

FIG. 1 shows a flow diagram for a plant 10 for processing a high-sulfur content diesel feed stream 12 into a low-sulfur content diesel fuel effluent stream 14. The feed stream 12 is first directed to autoxidation reactor 20 where hydrocarbons in the feed stream 12 are oxidized in the presence of air to form a peroxide-containing effluent stream 22. The peroxide containing effluent stream is directed to a second reactor 24 where the peroxide-containing stream 22 is subjected to an oxidation reactor where the sulfur compounds are oxidized to sulfones to form effluent stream 26 containing sulfones and unreacted peroxide compounds. The effluent stream 26 is directed to a third, peroxide decomposition reactor 28 where the peroxide compounds are decomposed to alcohol species under decomposition conditions and in the presence of a catalyst to form effluent stream 30. The effluent stream 30 is directed to a adsorber 32 containing an absorbing media such as silica gel where the sulfone species are absorbed to produce the ultra-low-sulfur content effluent stream, containing less than 10 wppm sulfur in line 14.

The term “diesel fuel” is defined in accordance with the specifications defined in the American Society for Testing and Materials (ASTM) Specification D 975 and refers to a petroleum fraction comprising primarily C₁₀-C₂₄ hydrocarbons (about 75 mass %), typically paraffins including straight-chained, branched, and cycloparaffins, and of aromatic hydrocarbons (about 25 mass %), such as alkylbenzenes and naphthalenes, and having distillation temperatures of about 260° C. at the 10% recovery point and about 340° C. at the 90% recovery point. The average net chemical formula for common diesel fuel is typically C₁₂H₂₆. The diesel fuel may be hydrotreated.

The first reactor 20, in a preferred form of the invention, is a continuous reactor with air recirculation operating at from 120° C. to 160° C. at a pressure of 900 psig to about 1500 psig and most preferably at about 1100 psig. Air is provided to the reactor 20 through line 40 to provide a ratio of oxygen content by weight to hydrocarbon content by weight from the feed stream 12 from about 0.005:1 to about 0.015:1 and most preferably 0.007:1 of oxygen by weight to hydrocarbon by weight. A recycle line 42 is provided for directing an effluent stream from the first reactor 20 back to the feed stream 12 at a ratio of rates of recycle flow rate to fresh feed flow rate of from about 3:1 to 5:1 and more preferably about 4:1. In one preferred form of the invention, the first reactor 20 will be seeded with wppm levels of organic peroxide.

Reactor 24 is preferably a continuous fixed bed oxidation reactor operated at temperatures from about 50° C. to 150° C. and utilizes the peroxide compounds generated in-situ in reactor 20 to convert sulfur compounds to sulfones, which are later removed in adsorber 32 by silica gel extraction. In a preferred form of the invention, 10 to 20 equivalents of peroxide per sulfur molecule are used to carry out the oxidation reaction. In a preferred form of the invention, a catalyst is used in reactor 24 which preferably contains desulfurization metals selected from the group consisting of cobalt, nickel, molybdenum, and tungsten.

The peroxide decomposition reactor 28 is a continuous, fixed bed type reactor preferably operated at a temperature from about 50° C. to about 150° C. and a pressure from about 15 to about 100 psig, and in the presence of a peroxide decomposition catalyst converts the peroxides into alcohols. In a preferred form of the invention, about 60% to about 100% of the peroxides will be decomposed into alcohols. Peroxide decomposition is desirable prior to reaching the silica-gel bed as peroxides are absorbed by the silica gel thereby reducing the capacity for the silica gel to remove oxidized sulfur compounds.

The peroxide decomposition catalyst, in a preferred form of the invention, is a catalyst capable of decomposing peroxides into alcohols and most preferably contains a metal, and even more preferably iron. In a 0.50 g sample of the catalyst the iron should be present in an amount by weight of from 100 ppm to about 15,000 ppm.

In a preferred form of the invention the catalyst contains an acidic material such as a zeolite and iron in framework and/or non-framework position. Suitable zeolites include zeolite beta, Y zeolite, MWW, UZM4, UZM-5, UZM-8, ZSM-18, MOR, MTW, and ZSM-5. Zeolite beta and ZSM-5 are especially preferred. The other examples of zeolites that can be used are those having known structure types, as classified according to their three-letter designation by the Structure Commission of the International Zeolite Association. Zeolite UZM-8 is defined in U.S. Pat. No. 6,756,030, which provides information on its unique structure as well as its synthesis details.

The acidic materials that constitute the catalyst can be formed into a variety of shapes such as pellets, extrudates, spheres, rings, trilobes, saddles, or other physical forms known in the art. Of course, not all materials can be formed into each shape. Preparation of the catalyst can also be done by means known in the art such as oil dropping, pressure molding, metal forming, pelletizing, granulation, extrusion, rolling methods and marumerizing.

The acidic zeolite will contain iron either within its framework or in a non-framework position. Iron can be introduced into the catalyst during the primary synthesis so that it is incorporated into the framework of the catalyst or impregnated into the catalyst so that the iron is absorbed in the catalyst in a non-framework position. What is meant by positioned in the framework of the catalyst is that the iron is covalently bonded to atoms that constitute the framework. A non-framework position is a position within the pores of the catalyst framework but not covalently bonded to an atom that constitutes the framework.

The adsorber 32 houses a bed of a material for absorbing oxidized sulfur compounds, and, in a preferred form of the invention the absorbing material is silica gel.

### EXAMPLES

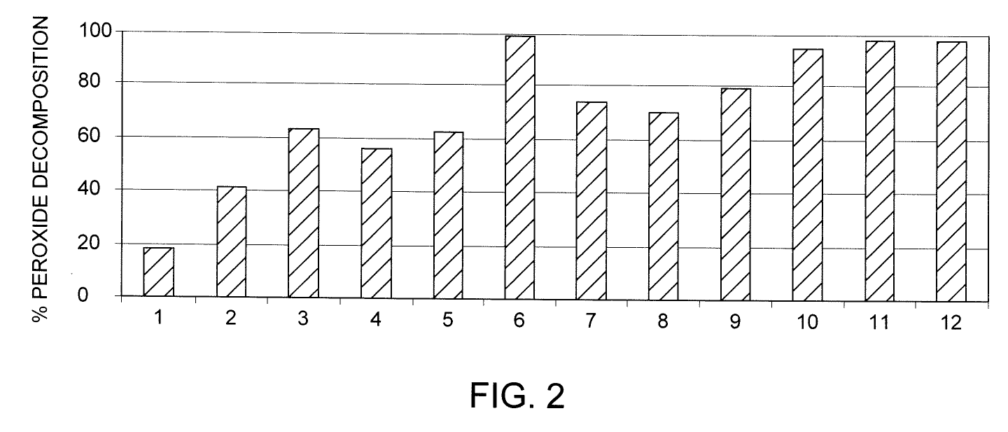

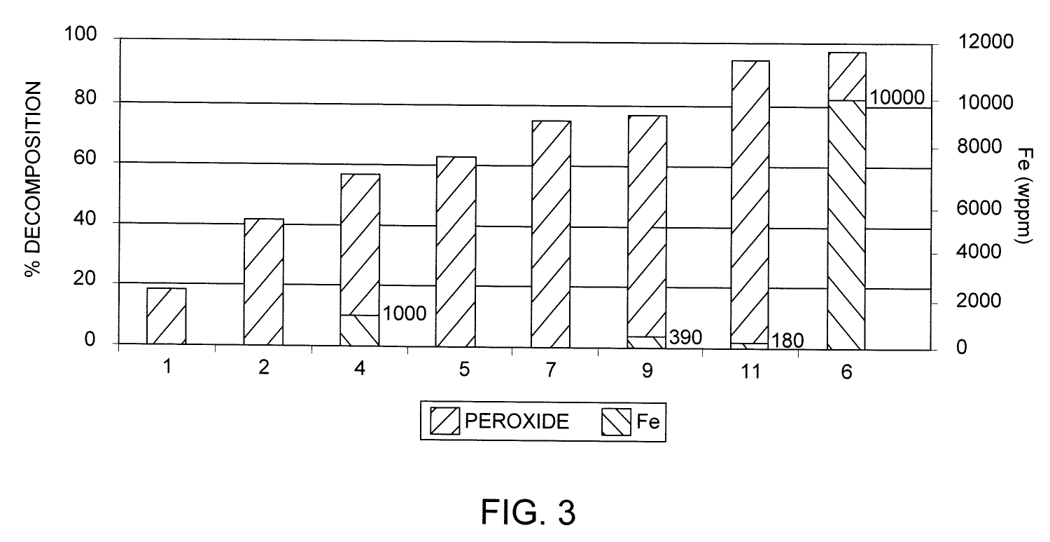

Catalyst particles in Table 1 below were prepared via primary synthesis and/or impregnation as described in Table 1 below. Twenty five grams of diesel fuel containing 1700 ppm peroxide and 0.5 g of catalyst material were added to a test reactor vessel. The contents of the vessel were heated to 90° C. for 21 hours. The amount of peroxide was measured after this period and the percent of peroxide decomposition was calculated and plotted by catalyst material in FIG. 2. FIG. 3 shows a representative sample of the catalysts of FIG. 2 in order of increasing peroxide decomposition percentage.

The catalyst designated as A in Table 1 is a sodalite bound iron with a 0% decomposition. Thus, using iron without a zeolite was not effective. The catalyst designated B is ZSM-5 alone without any iron and had a 0% peroxide decomposition. Catalyst A and B are not shown in FIGS. 2 and 3.

FIG. 3 shows a representative sample of the catalysts shown in FIG. 1 and in Table 1 in order of increasing peroxide decomposition percentage. The order is as follows: catalyst Nos. 1, 2, 4, 5, 7, 9, 11, and 6, with catalyst number 6 having a 99%, peroxide decomposition. According to Table 1, FIG. 2 and/or FIG. 3, Iron oxide (No. 1) by itself decomposes only 18% peroxide. Iron on beta zeolite (Nos. 6, 10, and 12), iron on ZSM-5 (Nos. 3, 4, 7, 8, and 11), and iron on Y zeolite (Nos. 2, 5, and 9) showed much greater activity for peroxide decomposition ranging from 56% to 99% under the same reaction conditions.

TABLE 1

| | Core | Wt. % of | Percent Peroxide |
|---|---|---|---|
| Number | Material | Iron | Decomposition |
| A | Sodalite | 16 | 0% |
| | Sodium Aluminum | | |
| | silicate mineral | | |
| B | ZSM-5 | 0 | 0 |
| 1 | Iron oxide | 70 | 18% |
| 2 | Fe-Y-zeolite | 0.03 | 41% |
| 3 | Fe-ZSM-5 | 0.6 | 63% |
| | primary | | |
| | synthesis | | |
| 4 | Fe-ZSM-5 | 0.10 | 56% |
| | impregnation | | |
| 5 | Fe-Y zeolite | 0.06 | 62% |
| 6 | Fe-Beta | 1.0 | 99% |
| | Zeolite | | |
| 7 | Fe-ZSM-5 | 1.0 | 74% |
| 8 | Fe-ZSM-5 | 0.1 | 70% |
| 9 | Fe-Y zeolite | 0.039 | 79% |
| 10 | Fe-Beta | 0.058 | 94% |
| | zeolite | | |
| 11 | Fe H-ZSM-5 | 0.018 | 98% |
| 12 | Fe-Beta | 0.50 | 98% |
| | zeolite | | |

The foregoing description, example and drawing clearly illustrate the advantages encompassed by the present invention and the benefits to be afforded with the use thereof.

What is claimed is:

1. A catalyst particle for decomposing a peroxide compound into an alcohol compound comprising:
an acidic zeolite material; and
an iron containing material positioned in the framework position or the non-framework position and being present in an amount by weight of the catalyst particle from 100 ppm to 10,000 ppm.

2. The catalyst particle of claim 1 wherein the zeolite is selected from the group consisting of zeolite beta, FAU, MWW, ZSM-18, MOR, MTW, and ZSM-5.

3. The catalyst particle of claim 1 wherein the acidic zeolite material is ZSM-5.

4. The catalyst particle of claim 1 wherein the acidic zeolite material is zeolite beta.

5. The catalyst particle of claim 1 wherein the iron containing material is in the framework position.

6. The catalyst particle of claim 1 wherein the iron containing material is in the non-framework position.

7. A process for decomposing a peroxide into an alcohol comprising:
providing a hydrocarbon containing feed stream containing a peroxide;
providing a catalyst particle of an acidic zeolite material containing iron either in the framework position or the non-framework position; and
passing the feed stream into contact with the catalyst particle to decompose from about 60% to about 100% of the peroxide into an alcohol to form an effluent stream.

8. The process of claim 7 wherein the feed stream contains sulfur compounds.

9. The process of claim 8 further comprising passing the effluent stream into contact with a bed of silica gel to remove the oxidized sulfur compounds.

10. The process of claim 9 wherein the iron is present in an amount by weight of from 100 ppm to 10,000 ppm.

11. The process of claim 10 wherein the acidic zeolite is selected from the group consisting of zeolite beta, FAU, MWW, ZSM-18, MOR, MTW, and ZSM-5.

12. The process of claim 10 wherein the acidic zeolite is zeolite beta.

13. The process of claim 10 wherein the acidic zeolite is ZSM-5.

14. The process of claim 7 wherein the iron is the framework position.

15. The process of claim 7 wherein the iron is in the non-framework position.

16. A process for decomposing a peroxide into an alcohol comprising:
providing a hydrocarbon containing feed stream containing peroxide compounds and sulfur compounds;
providing a catalyst particle of an acidic zeolite material containing iron either in the framework position or the non-framework position;
passing the feed stream into contact with the catalyst particle to decompose from about 60% to about 100% of the peroxide into an alcohol to form an effluent stream;
oxidizing the sulfur compounds to prepare oxidized sulfur compounds; and
passing the effluent stream into contact with a bed of silica gel to remove the oxidized sulfur compounds.

17. The process of claim 16 wherein the iron is present in an amount by weight of from 100 ppm to 10,000 ppm.

18. The process of claim 16 wherein the acidic zeolite is selected from the group consisting of zeolite beta, FAU, MWW, ZSM-18, MOR, MTW, and ZSM-5.

19. The process of claim 16 wherein the acidic zeolite is zeolite beta.

20. The process of claim 16 wherein the acidic zeolite is ZSM-5.
